(19) United States
(12) Patent Application Publication
(10) Pub. No.: US 2009/0177535 A1
(43) Pub. Date: Jul. 9, 2009

(54) SYSTEM AND METHOD FOR MONITORING AND EXECUTING SUBSTITUTE FULFILLMENT

(75) Inventors: Michael D. Vogt, Lewiston, MI (US); Gilbert Mosher, JR., Harbor Springs, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: PMP CORPORATION, Petoskey, MI (US)

(21) Appl. No.: 12/212,946

(22) Filed: Sep. 18, 2008

Related U.S. Application Data
(60) Provisional application No. 60/973,297, filed on Sep. 18, 2007.

(51) Int. Cl. G06Q 10/00; G06Q 50/00; G06F 17/30

(52) U.S. Cl. 705/11; 705/32; 707/104.1; 707/E17.044

(57) ABSTRACT

A system for substitute fulfillment having a management module that acquires and analyzes information regarding potential substitutes, wherein the module includes an application mode for acquiring substitute information, a preferences mode for providing preferences relevant to the substitute process and a grading mode for analyzing the substitute information, wherein substitute fulfillment is completed based on results obtained from said management module is provided. Also provided is a method of fulfilling substitute positions by entering substitute information into an application mode of a management module, verifying the entered information, and approving substitutes that fulfill substitute requirements.

### CROSS-REFERENCE TO RELATED APPLICATIONS

This application claims the benefit of priority to U.S. Provisional Patent Application Ser. No. 60/973,297 filed Sep. 18, 2007, and is incorporated herein by reference.

### BACKGROUND OF THE INVENTION

The present invention relates to substitute management, and more specifically to a system and method for providing substitutes.

Most organizations have occasions in which there is the need to temporarily fill a position vacated based upon an employee's absence. This is commonly referred as “substitute fulfillment.” Historically this was accomplished manually wherein, one, or a group of, employees sift through substitute listings to determine an appropriate substitute to replace an absent employee. In other words, tally sheets were maintained that record both absences and potential substitutes. The method was very labor-intensive and not cost-effective.

Based upon the need for a better method, several alternatives have been created, including automated call systems or computerized systems. Several computer systems have been developed to automate or partially automate the process. Such automated systems often include information relating to the substitution process, which include, but are not limited to, substitution criteria, registered substitutes, etc. This information is entered in a database through software that is maintained at the school district level. In order to utilize the software, typically the individual schools access the system through a dial-up connection with a modem from a computer located at the school. Thus, in order for the system to function properly, personnel at the district level must receive absence notification and initiate and oversee the substitute fulfillment procedure with support from the system. Based on these systems, increased involvement of school district personnel and the system vendor may be required, including hardware and software support of the system. This creates an increased burden on personnel.

Additional problems with the existing technology are due to equipment limitations, access constraints, and operation requirements. This is based primarily on the fact that each district typically purchases and installs a system and independently handles its own substitute fulfillment using the purchased system. The end result of such substitute fulfillment management systems, is a virtual impossibility for school districts to share information and common substitute fulfillment resources.

### SUMMARY OF THE INVENTION

The present invention provides a system and method for executing substitute fulfillment. The system analyzes the substitute requirements for each substitution, analyzes the available substitutes and provides appropriate substitutes to fill the position.

The system can also include a payroll module. The payroll module enables the system to not only provide substitute fulfillment, but also provide the necessary payment information and calculations. The payroll information can include calculations of the hourly pay, daily pay and other relevant payroll information.

The system can also include a human resource module detailing the amount of leave available, the amount previously used and other related human resource information.

These and other objects, advantages and features of the invention will be more fully understood and appreciated by reference to the description of the current embodiment and the drawings.

### BRIEF DESCRIPTION OF THE DRAWINGS

FIG. 1 is a flow chart depicting the manner in which information is processed using the ISD Module of the present invention.

FIG. 2 is a flow chart depicting the manner in which information is processed by the Payroll Module of the present invention.

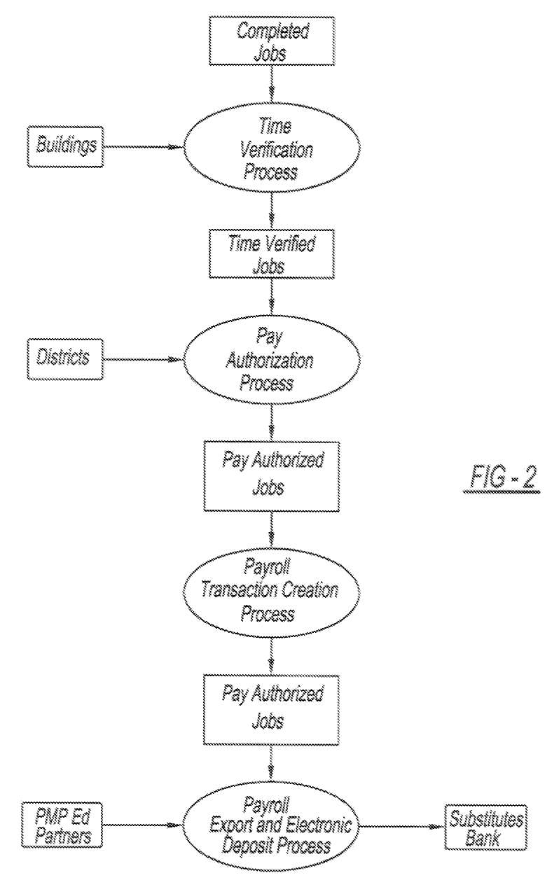

FIG. 3 is a flow chart depicting the manner in which information is processed by the Human Resources Module of the present invention.

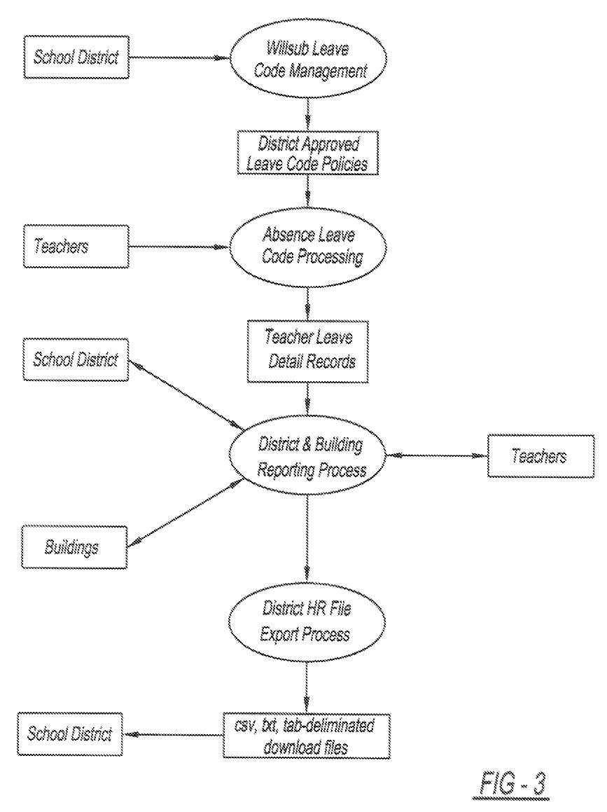

FIG. 4 is a data structure diagram of the contracted services.

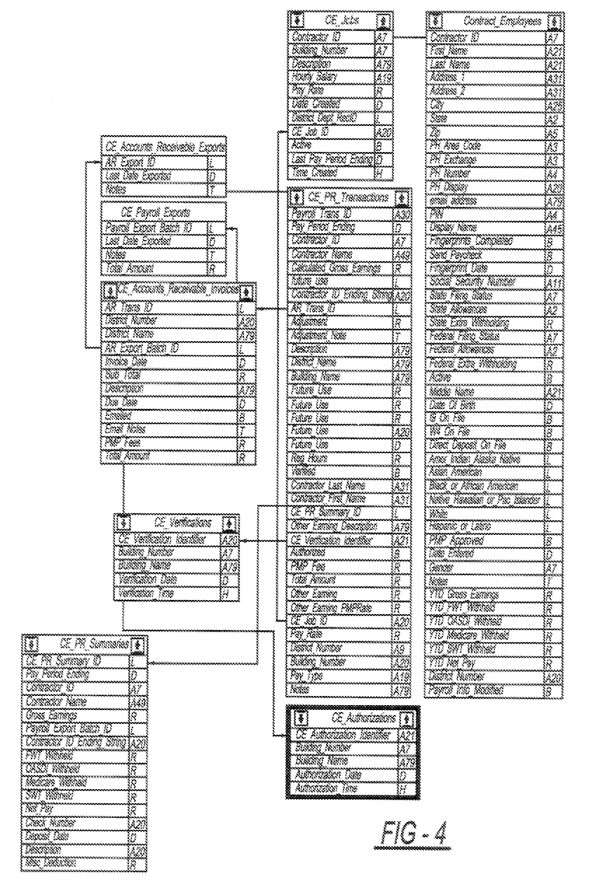

FIG. 5 is a data structure diagram of the district leave structure.

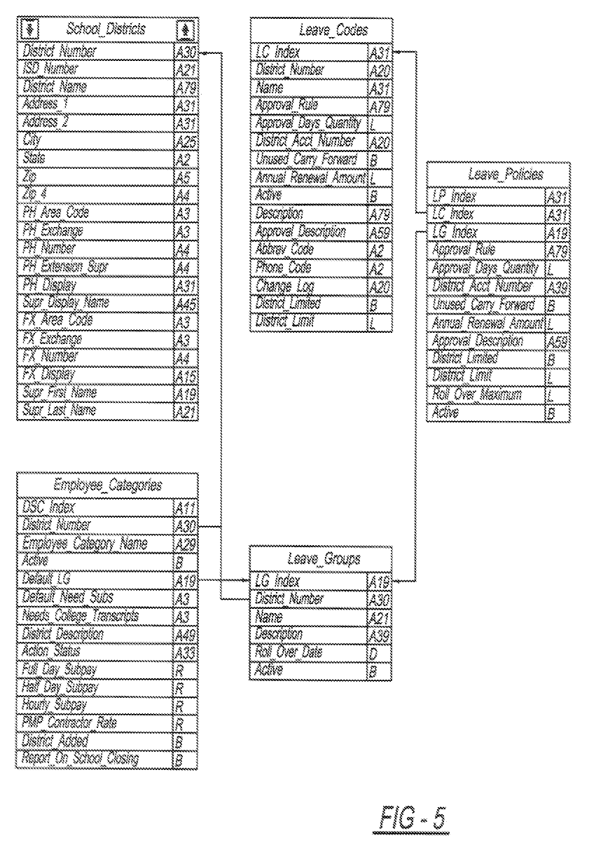

FIG. 6 is a data structure diagram of the employee leave requests.

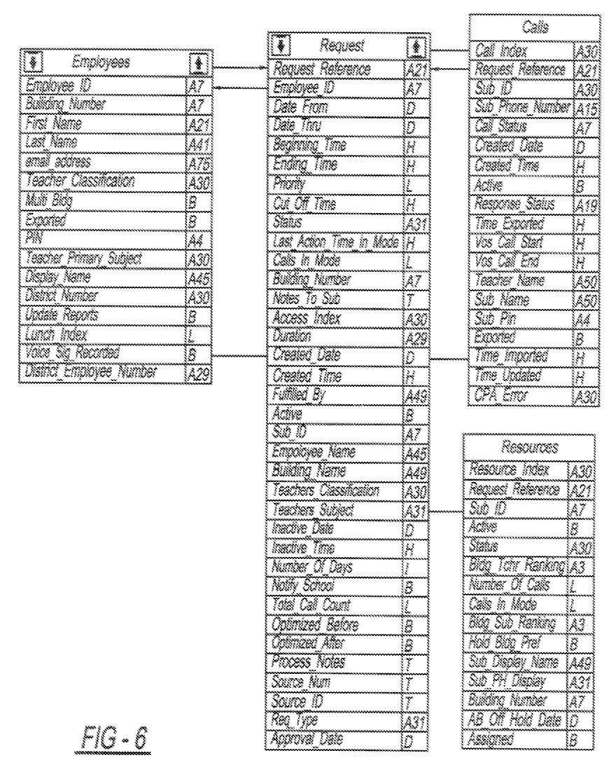

FIG. 7 is a data structure diagram of the entities and managers.

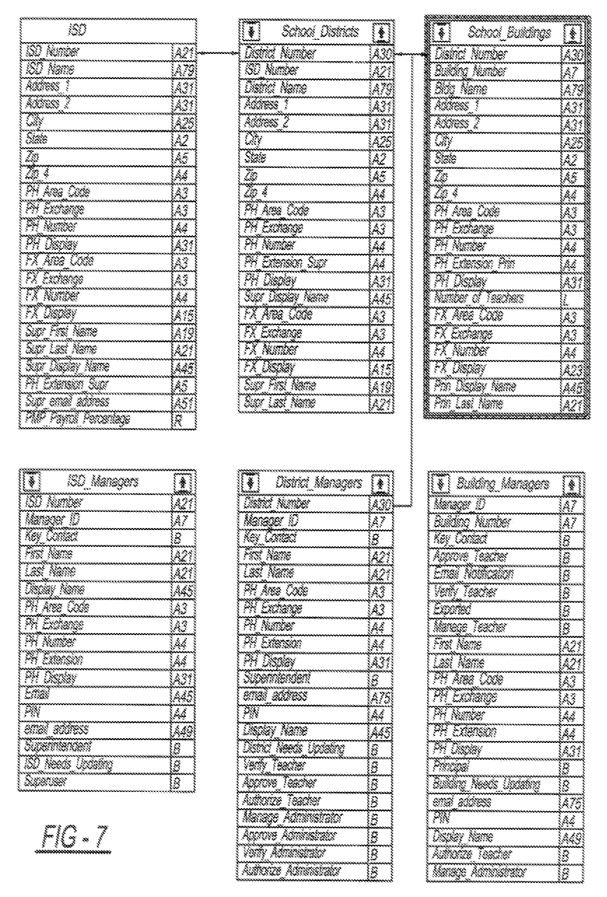

FIG. 8 is a data structure diagram of the substitute and building preferences.

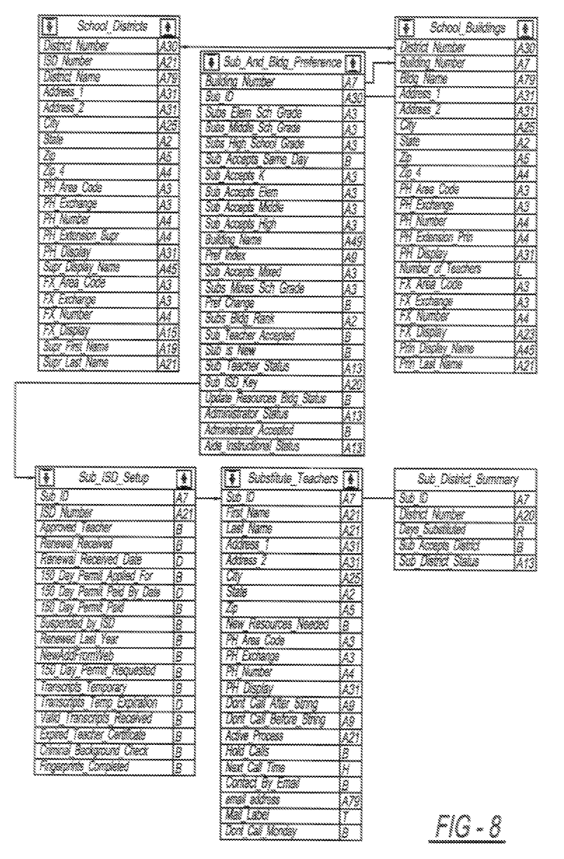

FIG. 9 is a data structure diagram of the verification and authorization process.

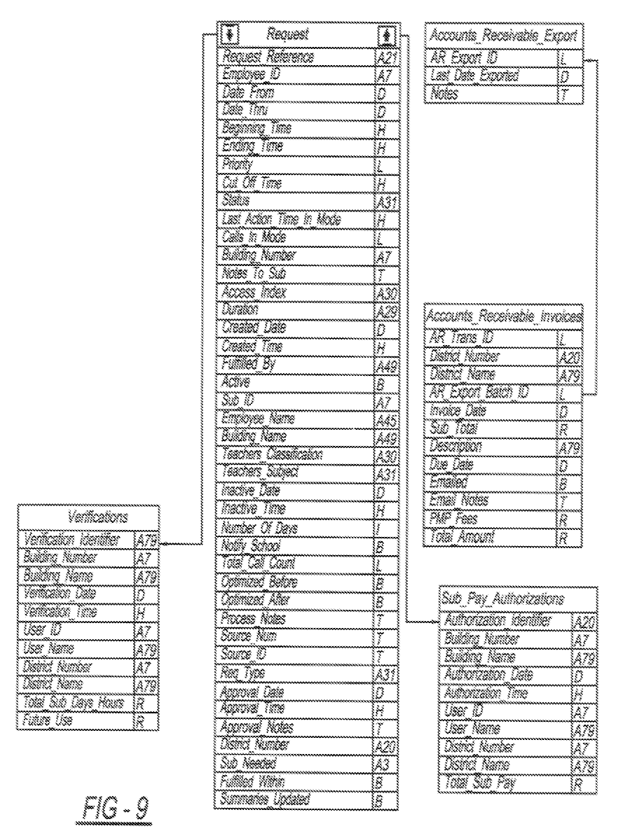

FIG. 10 is a data structure diagram of the district support structure.

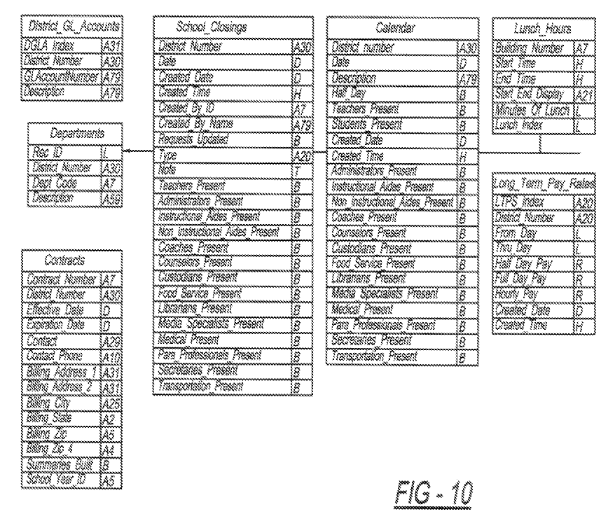

FIG. 11 is a data structure diagram of the employee leave tracking.

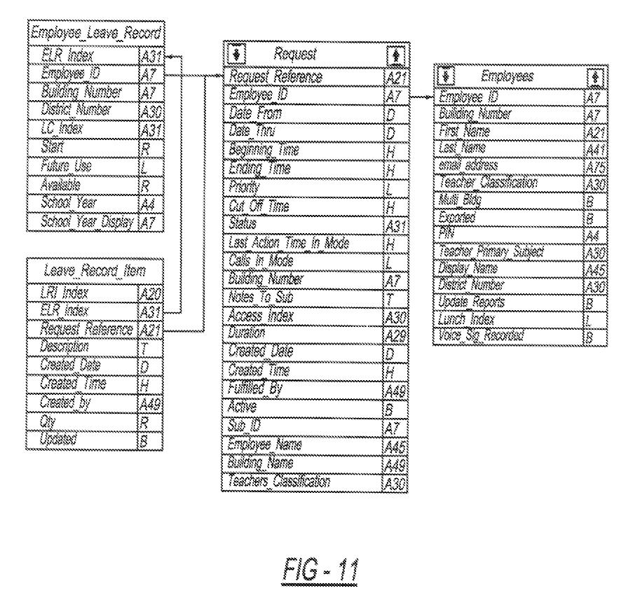

FIG. 12 is a data structure diagram of the leave process support data.

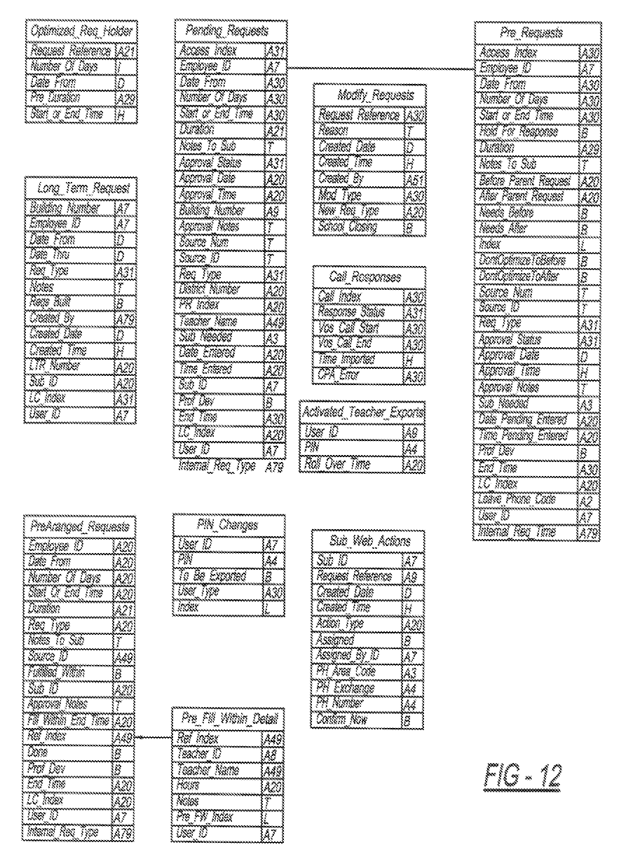

FIG. 13 is a data structure diagram of the user activity tracking.

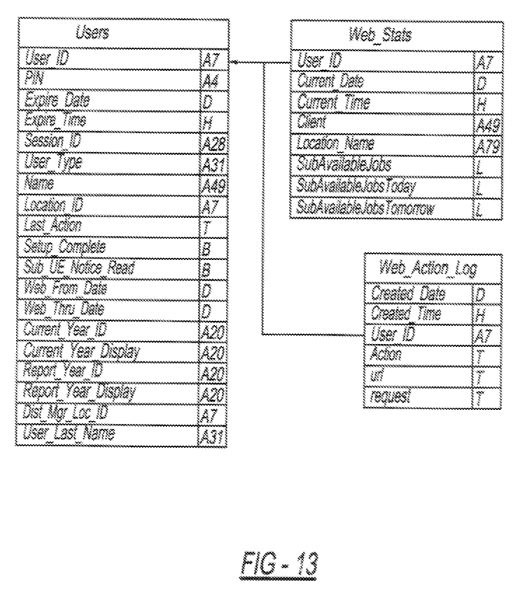

### DESCRIPTION OF THE CURRENT EMBODIMENT

Generally, the present invention provides a comprehensive system and method for executing substitute fulfillment. The system can be used in a variety of fields including, but not limited to, education, health care, retail, government, hospitality and corporate environments. In other words, the present invention provides a system and method enabling the user to completely monitor and otherwise provide support for substitute fulfillment.

More specifically, the system of the present invention includes a system for automatically managing and fully executing substitute fulfillment. By “fully executing substitute fulfillment,” it is meant that the system maintains a database of qualified individuals, ascertains the availability of qualified individuals based upon the need of the user and monitors all relevant information with regard to the qualified individuals. For example, the system can monitor the hours that the individual works, track all certifications maintained by the individual and track payments made to the individual. In the field of education, there are regulations at both state and federal levels for substitute employees. These regulations include, but are not limited to, 90 credit hours of college education, permits, fingerprinting within pre-determined date constraints and knowledge of the Right to Know and Bloodborne Pathogen laws. In monitoring all of this information, the system integrates pre-employment screening, state criteria, Intermediate School Districts (ISD) criteria, and district criteria, thereby removing the screening burden from the ISD. In other words, the present invention provides a system and method of substitute fulfillment that enables the user to monitor and otherwise provide support for substitute fulfillment in a manner previously unavailable.

Additionally, the system can track information with regard to an individual's leave/vacation using a Human Resources Module. The module enables the user to monitor and otherwise manage the leave an individual is taking and any balance of leave that the individual has available.

A Payroll Module can also be included with the system. The Payroll Module enables the system to acquire payroll information, such as the amount of time an individual worked and the individual's rate of compensation. The Payroll module enables the user to manage the payroll with little to no participation by the user. The system translates information regarding the substitute position into payroll transactions. This includes, but is not limited to, calculation of time worked, gross pay calculations, tax deductions and withholdings, paycheck reporting and electronic deposit functions.

The integrated payroll module is thorough, flexible and at the same time, easy to use. The payroll module ensures that the payroll is accurate and can be easily approved by district personnel. The payroll module combines a ‘Verification’ process with an ‘Authorization’ process that uniquely divides the effort amongst those individuals who have the closest dealings with the requirements. Verification is the first step in the payroll process. The system verification is the process whereby, a manager with appropriate permissions, verifies that the calculated time on the job is correct. This includes time for half-day, full-day jobs, as well as for hourly jobs. Substitutes typically work in one building at a time for a given leave request. The system provides the building manager with a list of completed jobs, the employee and substitutes names for each, and a calculated time (duration) of the job. Verification includes reviewing calculations and recording an indication that the calculation is correct. For example, the manager may check a box for each job they are verifying. This verification process could be presented to the verifier in application, web-based, or any other applicable form, to complete the process. Verification is typically quick, takes less than a minute to complete a weekly entry for a typical district. Even if there are changes to the time calculation, the system design optionally provides a pop-up list of appropriate time suggestions for the manager, which expedites editing a calculated time, and a ‘Verification Notes’ area to record the reason for the changes to the calculated time. Once verification is completed, a Verification record containing the total time verified is created, and a unique Verification Identifier is assigned.

Authorization includes authorizing the gross pay to the substitute, whose pay has been verified. Based on database tables that describe the substitute pay scale for an employee taking leave, the system calculates the gross pay for each verified request and displays a list to the district manager showing the absent employee, the substitute and the calculated gross pay. Similar to the verification process, if the calculated pay is correct, the district manager need only indicate that is the case, for example, by checking a box next to each record displayed on the web form, to authorize the substitute pay. When adjustments are necessary, the web form provides an adjustment area and an ‘Authorization Note’ area that includes any notes created during the verification process. When the district manager has authorized each leave request, an ‘Update’ button may be selected to complete the authorization process. When completed, the system creates a ‘Sub Pay Authorization’ record, which totals the pay authorized for the leave requests and assigns a unique ‘Authorization Identifier’ to each leave request in the group.

The Substitute Management Module brings the modules together so that there is more involvement between parties and updated information is immediately provided to all who need it.

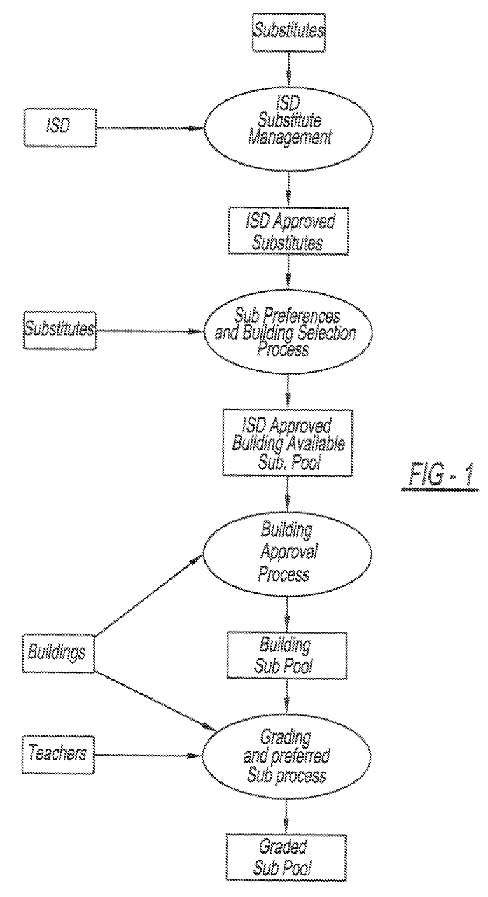

The following description of the various processes is meant to be a narrative that describes more fully the Data Flow Diagram as used in an exemplary school setting as shown in FIG. 1. Wherein, FIG. 1 details the Management Module for use in an ISD, which is defined as a group of school districts that generally follow county lines. Intermediate school districts provide various student and administrative services to its member districts. A School District is an education agency at the local level that exists primarily to operate public schools or to contract for public school services.

The ISD Manager is the person or persons at the ISD that manage the substitute teacher information for their districts.

The District Manager is the person or persons at the school district that set up the system options and parameters for the district, and who also authorize substitute pay.

The School Building is either a public or private educational facility that is managed by a principal.

The Building Manager is the person or persons in the school building that approve substitute teachers for the building and who also verify substitute time in the school building.

The Teacher is an individual instructor teaching in a school building.

The Substitute Teacher is an individual wishing to substitute teach in a building or buildings in a district or districts within an ISD.

The process begins when a substitute contacts the ISD manager to apply to substitute teach within the ISD. The ISD manager enters the substitute's Social Security Number (SSN) and Date of Birth (DOB) and checks to see if the substitute is already in the system. If the substitute is substituting in another ISD that is part of the system, their demographic information is retrieved and verified with the substitute. If they are new to the system, their demographic information is entered and verified by validation triggers in the Substitutes, Sub_ISD_Setup and SubAndBuildingPreferences databases. The ISD manager then proceeds to check to see if the necessary requirements have been met and reviews the necessary documentation, even if the substitute is approved in another ISD. The substitute has the option to request that the ISD apply for a permit for them and a grace period of 60 days is extended to allow the requisite governing authority to bill the substitute for the permit and for the substitute to pay the bill. The ISD is notified of pertinent information regarding permit payment as well as background check status. The substitute is then given ‘ISD Approved’ status, which is one of three requirements to enable a substitute to accept jobs in a school building. Once the substitute has been entered into the ISD, they are able to choose the school building in which they would like to substitute. Substitute preferences, such as which days they would like to work and at which times they would like to be contacted by phone, as well as which grade ranges in the building they would like to substitute for, may be entered into the system. Once the substitute is ISD approved and preferences are set, the substitute will appear on the school building's ‘New Sub’ list, and each building manager of a school building that the substitute has selected, is given the authority to approve or not approve the substitute for their building after reviewing the substitute's credentials. At this point, the grading process begins. The grading process enables district, buildings and teachers to prioritize which subs are preferred to substitute in the building or class, and the order in which they will be contacted for available jobs. The grades run from a top preference grade of ‘A1’ to a no thank you’ grade of ‘F2.’ There are two primary grading systems in the current embodiment that are available to a district/building. Of course, essentially any grading system could be used. The options are the ‘Administration Priority’ or the ‘Teacher Priority’ system. As the names imply, the Administration Priority gives the Administration the first priority in ordering the subs for available jobs, though teachers can still maintain an excluded subs list that will prevent an individual substitute from seeing available jobs for that teacher, even if given a high grade by the administrator. The Teacher Priority gives the teachers priority in ordering the subs for available jobs, though administrators still reserve the right to override teacher preferred subs if necessary. In the current embodiment, all new subs are given a default grade of B2 for all jobs unless otherwise specified by administrators and teachers.

More specifically, the Management Module may include an application mode, wherein information for hiring an individual may be obtained. This information can include, but is not limited to, social security number, name, address, phone numbers, date of birth and other necessary information. In the information mode, the name of the person is cross-referenced within the system to determine if the person has already been added to the system, and verifies that all necessary information has been entered into the system. The ISD is notified of any additional information that is required and permits and/or licenses that need to be obtained. The system of the current embodiment ensures strict enforcement of the rules through use of database trigger rules. A check of the status of each requirement may be done for each new substitute employee added, and every time a substitute record is modified. Only when each requirement is met, does a substitute employee become ‘ISD Approved’ for the particular employment category. This provides tremendous improvement over paper systems and spreadsheet models, because the approval is not left up to or based upon a person checking the requirements, but is enforced through the mandatory database trigger event.

In the current embodiment, the system functions as follows. Whenever a new substitute employee is added to an ISD, or whenever a new district/building is added to an existing ISD, a Sub_IDS_Setup record is created and a set of SubAndBuildingPreference records are created so that one record exists for the substitute for each building in the ISD, and one record exists for the building for each substitute employee in the ISD. This record creation is enforced by database trigger events (which are mandatory) and contains the necessary data fields for each employee category that must be satisfied before a substitute can accept jobs in a client building. A substitute indicates each building they would like to substitute in by selecting a building from a list. The substitute may change their employment status for each offered category from ‘No’ to ‘Yes’ and save their preference. Following this procedure triggers another database event, which changes the substitute's ‘Building Approval’ status to ‘New.” New substitutes are listed for each building authority and each substitute is individually approved before yet another enforced trigger, lists the substitute as an available resource to fulfill employee absences. This 3-step enforcement uniquely ensures that the necessary federal and state requirements, as well as building oversight and approval processes are strictly implemented, ensuring that only qualified substitute personnel are allowed to substitute for building employees.

The next mode is the Individual Preferences mode, wherein the substitute can provide essentially any preferences they have. For example, the preferences can be for preferred days to work, preferred locations, and preferred positions, preferred times to be called, preference for same day jobs and others.

Next is the Grading Mode, wherein management at the locations in need of personnel, can approve or not approve of an individual based on the credentials. In the current embodiment, management creates a grade for each individual that forms a prioritized list of the individuals. The flexible grading system fine tunes the availability of jobs to which a substitute employee can have access. The district may select between being ‘Building Prioritized’ or ‘Employee Prioritized’. This allows the district to give priority to the grades for a given substitute to be primarily biased towards the grade given by building managers or the employees themselves. The system may use the same database table SubAndBuildingPreferences, along with an employee PreferredSubstitute database, to create a compound grade for any given substitute when used, as a resource for any given employee. The range of compound grades is from a highly desired substitute grade of ‘A1’ through descending grades of ‘A2’, ‘B1’, ‘B2’, ‘C1’, ‘C2’, ‘D1’, ‘D2’, ‘F1’, and finally to a not desired at all grade of ‘F2’. This grade is dynamically assigned, based on the grades received and the prioritized answers provided by the individual, when an employee leave request resource list is created. Each new substitute added to an ISD is given a default grade of ‘B2’, though this is changeable by both building managers and employees.

Another component of the grading system of the current embodiment, is the design of a sliding scale of days exposed to available jobs calculation that uses a lookup table to determine dates when substitutes of a given grade will be taken off ‘a status of ‘Grade Hold’ for a given job. If the need for a substitute is several weeks in the future, the system will allow just the ‘A1’ graded substitutes to have access to the job for a variable interval determined by the lookup table before allowing access by subs graded an ‘A2’. This date of ‘coming off hold’ is variable depending on substitute grade and the number of days in the future of the leave request. This is a unique way of ensuring that the highest graded substitutes end up in the buildings. In addition, each resource record is checked against the substitute's prior commitments and the preferences, to determine if the substitute can be an active resource for this job. Substitute commitments may have been created by the system for jobs already taken, or for commitments entered by the substitute for other reasons of unavailability. If there is a commitment or preference conflict, the resource is marked as inactive for this leave request. This ensures that all active resources are truly available and desire to take this type of job, increasing fulfillment rate.

Once the above processes are completed, substitutes appear on a resource list for each new job and their priority for phone calls and availability via the website, are determined by their individual grades. Once the leave request and associated resource records are created, the system publishes the jobs on the internet via a web server, to those substitutes graded appropriately and whose resources are “active” for the job.

The system can also include a Human Resources Module. The Human Resources Module combines services to not only track the individual staff absences and their leaves, but provides a rich environment for every district to set up their unique contractual obligations. The system also provides the interface needed when districts want to inform staff of their leave balances on each paycheck.

The Human Resources services in the current embodiment, begin with a school district's contractual set up entry using the Leave Tracking functions. This is broken down into informational areas; these areas can include, but do not have to include, at least three separate but integrated informational areas: 1. Leave Codes; 2. Leave Groups; and 3. Leave Policies.

The Leave Codes define possible reasons any employee in the institution would request an absence for their regular duties. Some examples of these include, but are not limited to, Medical, Family Medical, Personal, Bereavement, Funeral, School Business, Professional Development, Jury Duty, etc. While not every leave code will necessarily be available to all employees or under the same policies, the leave code informational area will contain all possible reasons that any institutional employee could be absent. The human resource manager may define these leave codes and assign which of the codes will be active for the institution. The Leave Code data includes a name, description, an abbreviation, a phone code for calling in an absence and a district/institution account number for reporting purposes.

The Leave Groups define all the possible different groups in the institution for which the institution has contractual or other similar obligatory recording and reporting duties. Some examples of these include, but are not limited to, Instructional Staff, Support Staff, Clerical Staff, Custodial Services, Kitchen Services, etc. The human resource manager may set up the necessary groups and define which of them are active for the institution. The Leave Group data includes a name, description and active status.

The Leave Policies define all the policies for each active Leave Code for each active Leave Group. To clarify, if the user has five active Leave Codes for the institution and three active Leave Groups, there will be fifteen (15) Leave policies defining the five Leave Codes for each Leave Group. The Leave Policy can include approval rules, district limits, annual amounts, active status, maximum, if unused are carried forward, and district/(institution account number for reporting purposes. This flexibility allows the user to elect to make a certain Leave Code inactive for a certain group. This also means that for a given Leave Code, the user may set different maximums for each group and different approval policies for each group. Some groups may always, for example, need Personal Days to always require approval, while other groups may allow Personal Days to always be approved automatically. The district/institution account number of the policy overrides the district/institution account number of the Leave Code, which allows for greater reporting detail. In other words, for Leave Tracking reports, if a district/institution account number exist for the reported policy, it will be reported in place of the Leave Code district/institution account number. The Leave Tracking set up allows complete flexibility in the set up and reporting of employee leave activity. In addition, this tallying of employee absenteeism and availability of leave balances, is exportable to the district's employee payroll program and supports all common formats. These files may be imported such that each employee's pay stub may print the employee's leave balances.

The Human Resources module can also include the ability to assign a district/institution charge account for each employee. This data can be included in reports that can be exported, such that district/institution accounting personnel may easily capture the costs to different cost centers of employee absenteeism. One example is an employee in the Special Education department who takes a day off and the cost of the substitute can be imported into the district's accounting program and assigned to the Special Education budget automatically.

The system of the current embodiment can be run in a client-server database configuration to provide business logic execution, as well as a database web server for dynamic content, and a separate web server for static content and as a security layer to client data. When used via a web-based service, there is no requirement that the application or data be locally stored. In addition, an interactive voice (IVR) program can be driven by a separate database that provides a telephone interface for employee call-in and substitute call-out services. The system is designed such that the IVR services can operate independently of the business logic in an unusual business circumstance and vice versa, though our services are usually running concurrently.

The substitute fulfillment can also be used for independently contracted employees such as coaches, transportation workers, administration workers and custodial workers. The system can also include another service for customers/users, ‘Contracted Services.’ Customers may decide that the ideal relationship for one or a group of their employees is as a sub-contractor instead of as a regular employee. The benefits are that these sub-contractors are actually provider employees and are paid by provider an amount determined by the customer. Provider distinguishes between substitute employees and sub-contracted employees, in that sub-contracted employees work regular jobs for the customer and are not filling in for an absent employee. Substitutes are, by definition, substituting for a regular employee. Contracted Services allows customers to add employees to a ‘Contracted Employee’ database and to create multiple ‘Contracted Jobs’ for each employee, if desired. These sub-contractors are then subject to the employment requirements set by the state and federal authorities (similarly to substitutes), and once approved, are then approved as provider employees. The identical Verification and Authorization processes are used to handle payroll for the sub-contracted employees.

The above description is that of the current embodiment of the invention. Various alterations and changes can be made without departing from the spirit and broader aspects of the invention as defined in the appended claims, which are to be interpreted in accordance with the principles of patent law, including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A system for substitute fulfillment comprising:
a management module that acquires and analyzes information regarding potential substitutes, said module comprising:
an application mode for acquiring substitute information;
a preferences mode for providing preferences relevant to the substitute process; and
a grading mode for analyzing the substitute information;
wherein substitute fulfillment is completed based on results obtained from said management module.

2. The system of claim 1, wherein said application mode includes an information mode that acquires and verifies the accuracy of the information acquired and if appropriate creates a record.

3. The system of claim 2, wherein said preferences mode includes preference questions regarding substitute positions.

4. The system of claim 1, wherein said grading mode can have at least two modes.

5. The system of claim 4, wherein said modes are selected from Administration Priority and Teacher Priority.

6. The system of claim 1, further including a payroll module for managing payroll of substitutes.

7. The system of claim 1, further including a human resources module for tracking substitute activities.

8. The system of claim 7, wherein said human resources module includes a leave tracking function.

9. A method of fulfilling substitute positions by
entering substitute information into an application mode of a management module;
verifying the entered information; and
approving substitutes that fulfill substitute requirements.

10. The method of claim 9, further including a preferencing step that enables a potential substitute provide preferences regarding available positions.

11. The method of claim 10, wherein said preferencing step includes:
selecting buildings from a building preference checklist;
approving the substitute; and
listing the substitute on an approved list.

12. The method of claim 9, further including a grading step that grades approved substitutes.

13. The method of claim 9, further including a human resources managing step that monitors approved substitutes.

14. The method of claim 13, wherein said human resources managing step includes tracking leave of substitutes.

15. A system for contract employee employment comprising:
a management module that acquires and analyzes information regarding potential employees, said module comprising:
an application mode for acquiring employee information;
a preferences mode for providing preferences relevant to the employment process; and
a grading mode for analyzing the employee information;
wherein employment is completed based on results obtained from said management module.

16. The system of claim 15, wherein said application mode includes an information mode that acquires and verifies the accuracy of the information acquired and if appropriate creates a record.

17. The system of claim 16, wherein said preferences mode includes preference questions regarding substitute positions.

18. The system of claim 15, wherein said grading mode can have at least two modes.

19. The system of claim 15, further including a payroll module for managing payroll of employees.

20. The system of claim 15, further including a human resources module for tracking employee leave activities.
